(19) United States
(12) Patent Application Publication
(10) Pub. No.: US 2016/0341467 A1
(43) Pub. Date: Nov. 24, 2016

(54) ACTIVE AIR FILTER ASSEMBLIES FOR REFRIGERATOR APPLIANCES

(71) Applicant: General Electric Company, Schenectady, NY (US)

(72) Inventors: Alan Joseph Mitchell, Louisville, KY (US); Joel Erik Hitzelberger, Louisville, KY (US); Keith Wesley Wait, Louisville, KY (US)

(21) Appl. No.: 14/719,368

(22) Filed: May 22, 2015

(51) Int. Cl. F25D 17/04; B01D 46/00; B01D 46/42

(52) U.S. Cl. CPC F25D 17/042; B01D 46/429; B01D 46/0005; B01D 46/0038; B01D 46/0028; F25D 2317/0415; F25D 2317/0417

(57) ABSTRACT

Refrigerator appliances and active air filter assemblies therefor are provided. A refrigerator appliance includes a main controller configured to control refrigerator appliance operations, and a connector port in communication with the main controller and accessible within a fresh food chamber, the connector port configured to provide at least one of data communication with the main controller or electrical power. The refrigerator appliance further includes an active air filter assembly which includes a housing, an inlet aperture defined in the housing, an outlet aperture defined in the housing, and a fan disposed within the housing and operable to actively flow air through the inlet aperture and outlet aperture. The air filter assembly further includes a connector plug connectable to the connector port to receive the at least one of data communication with the main controller or electrical power.

### FIELD OF THE INVENTION

The present subject matter relates generally to refrigerator appliances, and more particularly to active air filter assemblies which may be utilized with refrigerator appliances.

### BACKGROUND OF THE INVENTION

Refrigerator appliances generally include a cabinet that defines a chilled chamber for receipt of food items for storage. For example, the cabinet can define a fresh food chamber and, may further define a freezer chamber. The fresh food chamber can be maintained at a temperature greater than the freezing point of water. Conversely, the freezer chamber can be maintained at a temperature equal to or less than the freezing point of water.

In many cases, refrigerator appliances include built-in air filters for filtering the air within the fresh food chamber to remove odors, etc. However, in many cases, the filter mediums of built-in air filters require frequent changing, and it may be difficult for a user to determine when such change is required.

Further, some refrigerators do not include such air filters, requiring a consumer to do without refrigerator appliance air filtration or purchase an aftermarket filter. Know aftermarket filters, however, are typically passive filters which do not actively force air therethrough. Passive filters are generally considered undesirable for use in refrigerator appliances. Further, known active filters utilizable with refrigerator appliances are battery powered, and battery replacement can be expensive for the consumer.

Accordingly, improved air filters for refrigerator appliances are desired in the art. In particular, improved active air filters would be advantageous.

### BRIEF DESCRIPTION OF THE INVENTION

Aspects and advantages of the invention will be set forth in part in the following description, or may be apparent from the description, or may be learned through practice of the invention.

In accordance with one embodiment, a refrigerator appliance is provided. The refrigerator appliance includes a cabinet defining a fresh food chamber, a door for accessing the fresh food chamber, and a main controller configured to control refrigerator appliance operations. The refrigerator appliance further includes a connector port in communication with the main controller and accessible within the fresh food chamber, the connector port configured to provide at least one of data communication with the main controller or electrical power. The refrigerator appliance further includes an active air filter assembly. The air filter assembly includes a housing, an inlet aperture defined in the housing, an outlet aperture defined in the housing, and a fan disposed within the housing and operable to actively flow air through the inlet aperture and outlet aperture. The air filter assembly further includes a connector plug connectable to the connector port to receive the at least one of data communication with the main controller or electrical power.

In accordance with another embodiment, a refrigerator appliance is provided. The refrigerator appliance includes a cabinet defining a fresh food chamber, a door for accessing the fresh food chamber, and a main controller configured to control refrigerator appliance operations. The refrigerator appliance further includes a connector port in communication with the main controller and accessible within the fresh food chamber, the connector port configured to provide serial communication with the main controller and electrical power. The refrigerator appliance further includes an active air filter assembly. The air filter assembly includes a housing, an inlet aperture defined in the housing, an outlet aperture defined in the housing, a process control block microprocessor configured for serial communication with the main controller, and a fan disposed within the housing and operable to actively flow air through the inlet aperture and outlet aperture. The air filter assembly further includes a connector plug connectable to the connector port to receive the serial communication with the main controller and electrical power. The fan is powered by the electrical power from the connector port.

In accordance with another embodiment, an active air filter assembly for connection to a connector port that is configured to provide serial communication and electrical power is provided. The air filter assembly includes a housing, an inlet aperture defined in the housing, an outlet aperture defined in the housing, a process control block microprocessor configured for serial communication through the connector port. The air filter assembly further includes a fan disposed within the housing and operable to actively flow air through the inlet aperture and outlet aperture, the fan configured to be powered by the electrical power from the connector port. The air filter assembly further includes a connector plug connectable to the connector port to receive the serial communication and electrical power.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of a refrigerator appliance with doors in closed positions in accordance with one embodiment of the present disclosure;

FIG. 2 provides a front, elevation view of the refrigerator appliance of FIG. 1 with doors of the refrigerator appliance shown in open positions to reveal a fresh food chamber of the refrigerator appliance and an ice making assembly in accordance with one embodiment of the present disclosure;

FIG. 3 illustrates an air filter assembly exploded from a connector port which is accessible within the fresh food chamber and in communication with a controller which is in turn in wireless communication with a user interface device;

FIG. 4 is a cross-sectional view of an air filter assembly in accordance with one embodiment of the present disclosure; and

FIG. 5 is a schematic diagram illustrating the communication between various components of an air filter assembly and refrigerator appliance in accordance with one embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

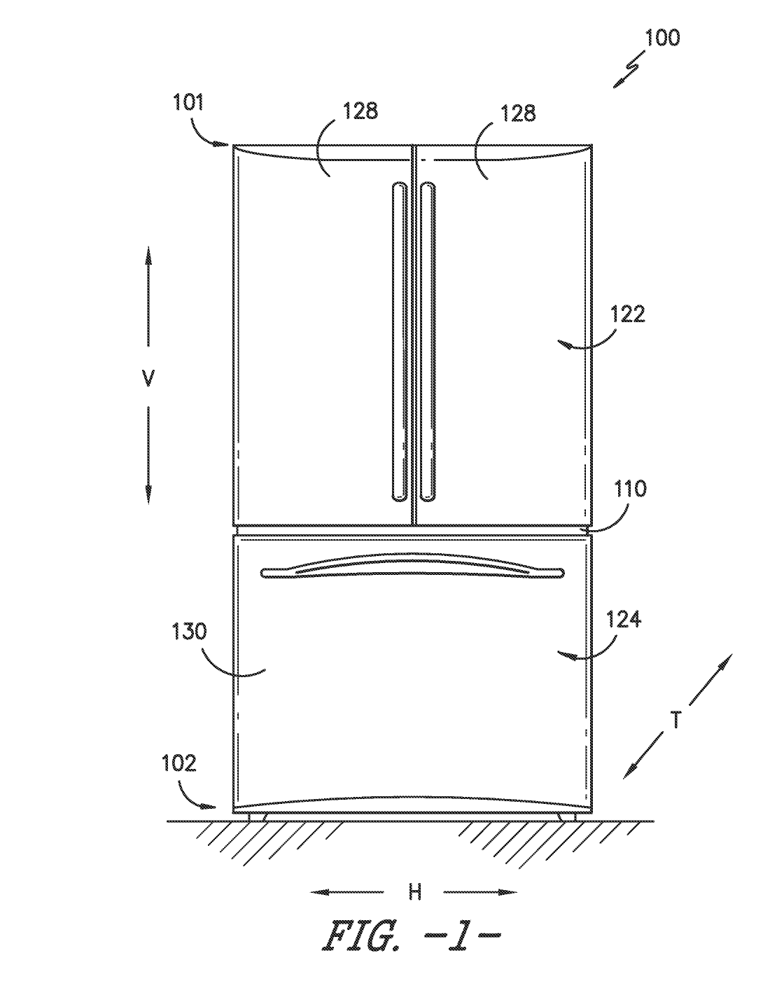

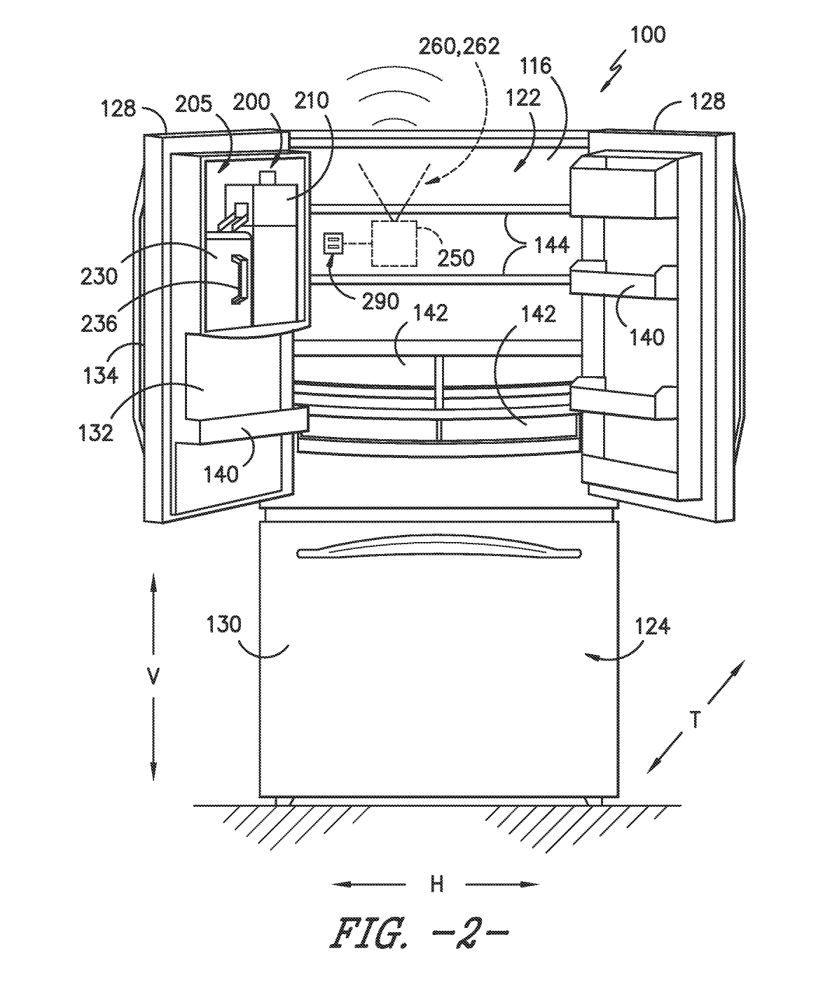

FIG. 1 provides a front, elevation view of a refrigerator appliance 100 according to an exemplary embodiment of the present subject matter with refrigerator doors 128 of the refrigerator appliance 100 shown in a closed position. FIG. 2 provides a front, elevation view of refrigerator appliance 100 with refrigerator doors 128 shown in an open position to reveal a fresh food chamber 122 of refrigerator appliance 100. Refrigerator appliance 100 includes an ice making assembly 200. In exemplary embodiments as shown, the ice making assembly 200 can be positioned, when the doors 128 are in closed positions, generally within or adjacent to a fresh food chamber 122 of refrigerator appliance 100. Alternatively, however, the ice making assembly 200 can be positioned, when the doors 128 are in closed positions, generally within or adjacent to a freezer chamber 124 of refrigerator appliance 100.

Refrigerator appliance 100 includes a cabinet or housing 110 that extends between a top portion 101 and a bottom portion 102 along a vertical direction V. Cabinet 110 defines chilled chambers for receipt of food items for storage. In particular, as shown, cabinet 110 defines fresh food chamber 122 positioned at or adjacent top portion 101 of cabinet 110 and a freezer chamber 124 arranged at or adjacent bottom portion 102 of cabinet 110. Fresh food chamber 122 is thus in these embodiments disposed above freezer chamber 124 along the vertical direction V. As such, refrigerator appliance 100 is generally referred to as a bottom mount refrigerator appliance. It is recognized, however, that the benefits of the present disclosure apply to other types and styles of refrigerator appliances such as, e.g., a top mount refrigerator appliance or a side-by-side style refrigerator appliance. Consequently, the description set forth herein is for illustrative purposes only and is not intended to be limiting in any aspect to any particular refrigerator chamber configuration.

In exemplary embodiments as illustrated, cabinet 110 includes a first sidewall 112 and a second sidewall (not shown), which are generally spaced apart along a horizontal direction H. Further, cabinet 110 may include a rear wall 116, which may be generally spaced apart from refrigerator door(s) 128 and freezer door(s) 130 of the refrigerator appliance 100 generally along a transverse direction T. The vertical, horizontal and transverse directions V, H, T may each be perpendicular to each other. Sidewalls 112 and rear wall 116 of cabinet 110 may define the fresh food chamber 122 and freezer chamber 124.

One or more refrigerator doors 128 are rotatably mounted or hinged to an edge of cabinet 110 for selectively accessing fresh food chamber 122. Each door 128 may include an inner surface 132 and an outer surface 134, between which the door 128 is generally defined. In addition, one or more freezer doors 130 are arranged below refrigerator doors 128 for selectively accessing freezer chamber 124. Freezer door 130 is coupled to a freezer drawer (not shown) slidably mounted within freezer chamber 124. As discussed above, refrigerator doors 128 and freezer door 130 are shown in the closed position in FIG. 1, and refrigerator doors 128 are shown in the open position in FIG. 2.

Turning now to FIG. 2, various storage components are mounted within fresh food chamber 122 to facilitate storage of food items therein as will be understood by those skilled in the art. In particular, the storage components include drawers 142 and racks 144 that are mounted within fresh food chamber 122. Bins 140 may additionally be provided, such as mounted on doors 128, and may be disposed within fresh food chamber 122 when the doors 128 are in the closed position. Bins 140, drawers 142, and racks 144 are configured for receipt of food items (e.g., beverages and/or solid food items) and may assist with organizing such food items. As an example, drawers 142 can receive fresh food items (e.g., vegetables, fruits, and/or cheeses) and increase the useful life of such fresh food items.

As may be seen in FIG. 2, an ice making assembly 200 according to an exemplary embodiment of the present subject matter is included in refrigerator appliance 100. Ice making assembly 200 may be disposed within the fresh food chamber 122, the freezer chamber 124, or a door 128, 130. In exemplary embodiments, as discussed herein, ice making assembly 200 may be disposed within a door 128. Thus, ice-making assembly 200 can be positioned within fresh-food chamber 122, e.g., when refrigerator doors 128 are closed. Ice-making assembly 200 is configured for producing ice, as is generally understood.

In embodiments wherein ice-making assembly 200 is disposed within a door 128, as shown, ice-making assembly 200 generally includes an ice box 205, which is generally an area defined in one of the doors 128. Various components of the ice-making assembly 200, such as an ice maker 210 and a container 230, may be disposed within the ice box 205. Ice maker 210 is configured for producing ice. As an example, ice maker 210 can be a nugget or auger style ice maker. Ice produced by ice maker 210 may be provided to and contained in container 230 until use by a consumer. In some embodiments, container 230 may for example include a handle 236 for easy of removal by a consumer. In additional or alternative embodiments, refrigerator appliance 100 may include suitable apparatus for on demand dispensing of ice from container 230 through, for example, an ice chute (not shown).

Refrigerator appliance 100 may further include a main controller 250. Main controller 250 may generally be configured to control refrigerator appliance 100 operations, as is generally understood. For example, various inputs, sensors and displays (not shown), such as temperature inputs, temperature sensors, etc. may be in communication with main controller 250. Additionally, the refrigeration cycle apparatus may be in communication with main controller 250. Main controller 250 may be configured to receive signals from such components and transmit signals to such components to control refrigerator appliance 100 operations.

Main controller 250 may include a memory and microprocessor, such as a general or special purpose microprocessor operable to execute programming instructions or micro-control code associated with operation of refrigeration appliance 100. The memory may represent random access memory such as DRAM, or read only memory such as ROM or FLASH. In one embodiment, the processor executes programming instructions stored in memory. The memory may be a separate component from the processor or may be included onboard within the processor. Alternatively, main controller 250 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Various components as discussed above and as discussed below may be in communication with main controller 250 via one or more signal lines or shared communication busses.

As further illustrated, a wireless transmission device 260 may be in communication with the main controller 250. The wireless transmission device 260 may be operable to wirelessly transmit data signals. Wireless transmission utilizes electromagnetic or acoustic waves to transmit data signals through atmospheric space rather than along a wire. Wireless transmission device 260 may, for example, be a component of a router, as is generally understood, which is in communication with main controller 250. A wireless receiver 262 may additionally be included in communication with the main controller 250, and may for example be integrated with wireless transmission device 260 or be a component of a router.

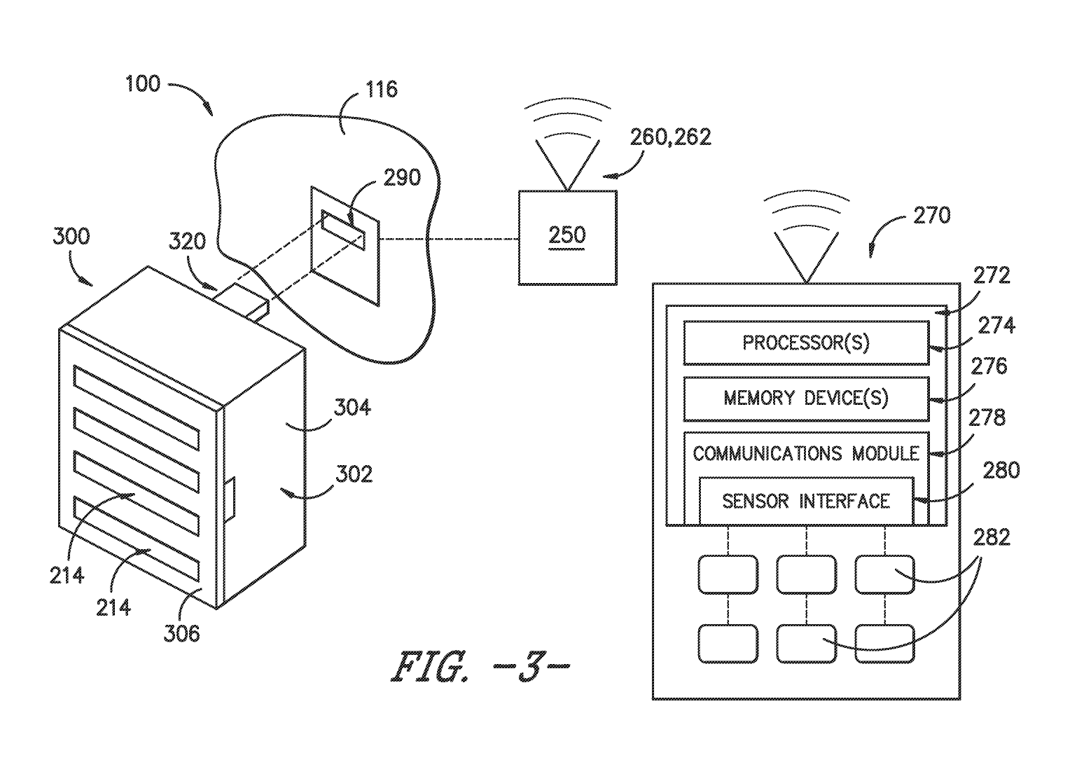

Referring still to FIG. 3, main controller 250 may be in wireless communication with a user interface device 270. The user interface device 270 may provide the user with access to refrigerator appliance 100 information, such as temperature settings and performance indicators, and may be operable, such as by the user, to modify various settings. The user interface device 270 in exemplary embodiments is independent from refrigerator appliance 100, and may in some embodiments be, for example, a computer (such as a desktop computer or a laptop), a tablet, a personal telephone (such as a suitable smartphone), or an independent device which functions solely to operate and communicate with the refrigerator appliance 100.

User interface device 270 may, include a controller 272. The controller 272 may include one or more processor(s) 274 and associated memory device(s) 276 configured to perform a variety of computer-implemented functions (e.g., performing the methods, steps, and the like disclosed herein). Additionally, the controller 272 may also include a communications module 278 to facilitate communications between the device 270 and the main controller 250. For instance, the communications module 278 may serve as a wireless interface to permit the controller 272 to transmit and/or receive refrigerator appliance 100 information. Moreover, the communications module 278 may include an interface 280 (e.g., one or more analog-to-digital converters) to permit input signals to be converted into signals that can be understood and processed by the processor 274. The interface 280 may include or be in communication with input selectors 282 of the device 270, through which a user may provide various inputs are desired.

Referring now again to FIGS. 2 and 3, in some embodiments, a connector port 290 may be included in refrigerator appliance 100. As shown, connector port 290 may be accessible within the fresh food chamber 122, such as through the rear wall 116 as shown or the first sidewall 112 or second sidewall. Connector port 290 may be in communication with the main controller 250, and may be configured to provide data communication with the main controller 250 and/or electrical power. In exemplary embodiments, for example, the connector port 290 may provide both data communication with the main controller 250 and electrical power. The data communication may, for example, be serial communication. For example, in exemplary embodiments, the connector port 290 may be a universal serial bus (“USB”) port.

Referring now to FIGS. 3 through 5, the present disclosure is further directed to air filter assemblies 300 for use in refrigerator appliances 100. Advantageously, air filter assemblies 300 in accordance with the present disclosure are active air filter assemblies 300, which actively flow air therethrough for filtering. For example, as discussed herein, an air filter assembly 300 may include a fan, rotation of which flows air through the air filter assembly 300. Air filter assemblies 300 in accordance with the present disclosure may advantageously be relatively inexpensive, reliable, and long lasting, and may be advantageously added as after-market additions to refrigerator appliances 100.

An air filter assembly 300 in accordance with the present disclosure includes a housing 302, which may for example include a body 304 and a door 306 for accessing an interior 308 of the body 304. Various other components of assembly 300 as discussed herein may be included within interior 308. Door 306 may be pivotable, removable, or otherwise movable between open and closed positions.

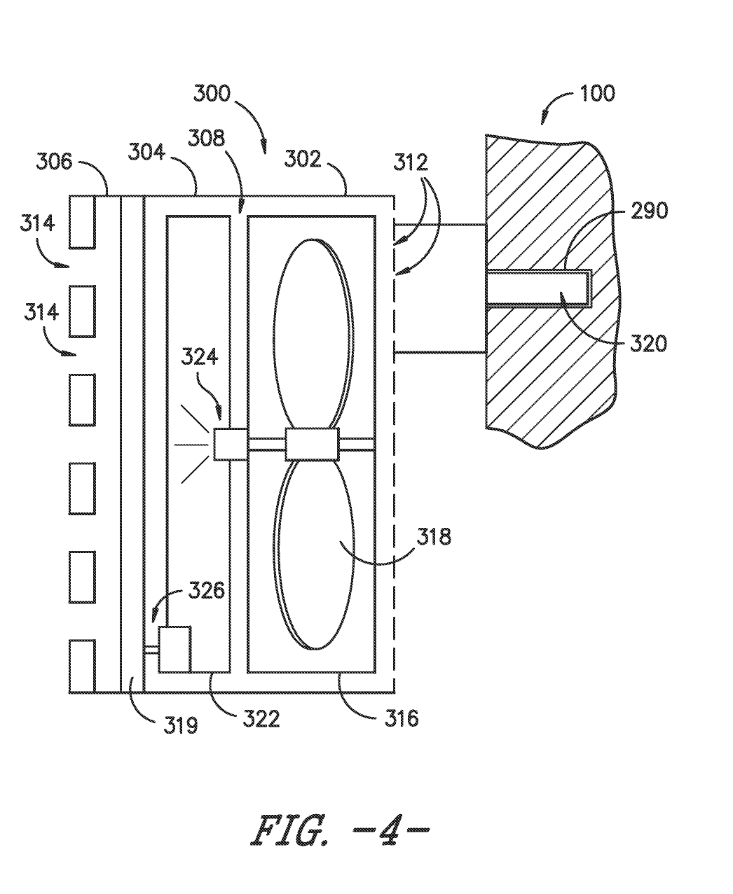

One or more inlet apertures 312 and one or more outlet apertures 314 may be defined in the housing 302, such as in the body 304 and/or door 306. For example, FIGS. 3 and 4 illustrate inlet apertures 312 defined in the body 304 and outlet apertures 314 defined in the door 306. Air may be actively flowed from exterior to the housing 302 through the inlet apertures 312 into the interior 308, and actively flowed from the interior 308 through the outlet apertures 314 to exterior to the housing 302.

Air filter assembly 300 may further include a fan 316 disposed within the housing 302, such as in the interior 308. Fan 316 may, for example, include blades 318 rotatably connected to a motor (not shown). The fan 316 may be operable to actively flow air through the inlet apertures 312 and outlet apertures 314, as discussed. For example, blades 318 may be rotatable about a central axis to generate air flow within the interior 308, thus actively flowing air through the inlet apertures 312 and outlet apertures 314.

Air filter assembly 300 may further include a filter medium 319 which is positioned to filter air flowed through the housing 302. For example, filter medium 319 may be disposed within housing 302, such as in interior 308, and between inlet apertures 312 and outlet apertures 314. Air flowing between inlet apertures 312 and outlet apertures 314 may thus pass through filter medium 319 and be filtered to removed particulates, etc. as is generally understood.

Any suitable material(s) and/or structures may be utilized for filter medium 319. For example, filter medium 319 may be a carbon filter formed from a carbon material, which in exemplary embodiments may be an active carbon material. Alternatively, a suitable woven or non-woven fabric, molecular sieve, or other suitable structure/material may be utilized.

In some embodiments, filter medium 319 may further include a catalyst coated thereon. The catalyst may be activated to kill bacteria, pollutants, etc. The catalyst may, for example, be activated by ultraviolet lightwaves. In exemplary embodiments, for example, a catalyst formed from TiO2 may be utilized.

Air filter assembly 300 may further include a connector plug 320 that is connectable to the connector port 290 to receive the data communication with the main controller 250 and/or the electrical power provided by the connector port 290.

Accordingly, when data communication is received, data can be transmitted and received to other components of air filter assembly 300 which are in communication with connector plug 320 through the plug 320 / port 290 connection. Further, when electrical power is received, other components of air filter assembly 300 which are in communication with connector plug 320 can be powered through the plug 320/port 290 connection.

In exemplary embodiments, for example, the connector plug 320 may receive both data communication with the main controller 250 and electrical power. The data communication may, for example, be serial communication. For example, in exemplary embodiments, the connector plug 320 may be a universal serial bus (“USB”) plug.

In exemplary embodiments, fan 316 may be configured to be, and when installed may be, powered by electrical power from the connector port 290. For example, fan 316 may be in communication with the connector plug 320 such that electrical power is received by fan 316 from a power source through connector port 290 and connector plug 320 when connector plug 320 is connected to connector port 290. Alternatively, however, fan 316 may be powered by another suitable energy source, such as batteries or another suitable electrical connection.

In exemplary embodiments, air filter assembly 300 may further include a process control block (“PCB”) microprocessor 322. The PCB microprocessor 322 may generally be configured to control operations of the air filter assembly 300, some of which are discussed herein. Further, in exemplary embodiments, the PCB microprocessor 322 may be configured for data communication with the controller 250, and may thus transmit and/or receive data with the controller 250. For example, PCB microprocessor 322 may be in communication with the connector plug 320 such that data communication is received by PCB microprocessor 322 from controller 250 through connector port 290 and connector plug 320 when connector plug 320 is connected to connector port 290.

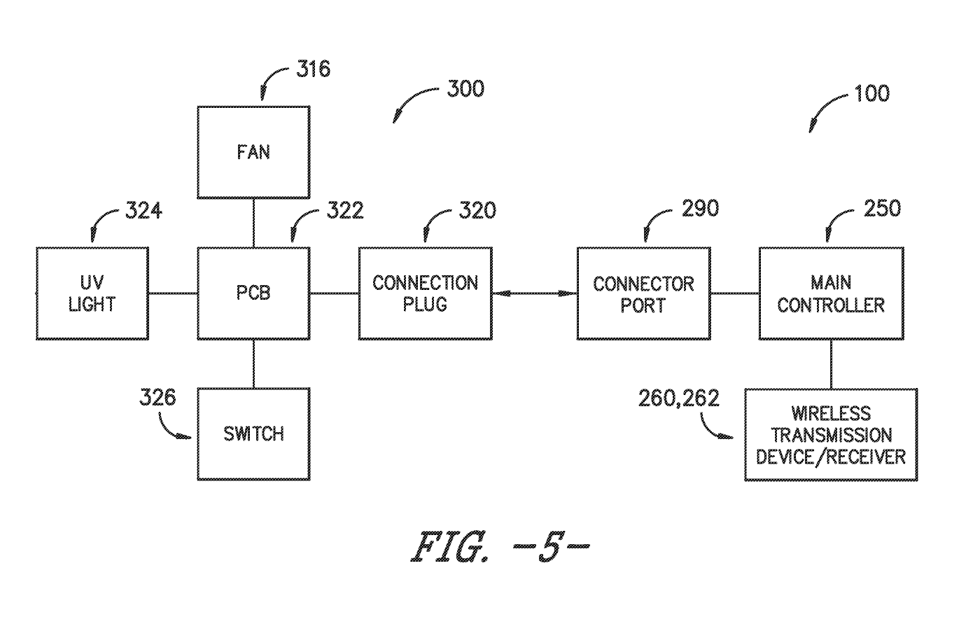

In exemplary embodiments, as illustrated in FIG. 5, PCB microprocessor 322 may be in direct communication with connector plug 320 (such as through a wired connection), and other components such as fan 316 as well as an ultraviolet light and switch as discussed herein may be in indirect communication with the connector plug 320 through the PCB microprocessor 322 (such as through a wired connection with PCB microprocessor 322).

Referring again to FIGS. 4 and 5, in some embodiments air filter assembly 300 may further include an ultraviolet light 324 which may emit ultraviolet lightwaves. The light 324 may be disposed within the housing 302, such as in the interior 308. In exemplary embodiments, the light 324 may be oriented to emit ultraviolet lightwaves towards the filter medium 319. For example, as discussed, filter medium 319 may include a catalyst which is activated by ultraviolet lightwaves. Actuation of the light 319 may emit ultraviolet lightwaves towards the filter medium 319, which may advantageously activate the catalyst and, for example, cause photocatalytic oxidation. Alternatively, no filter medium 319 may be included, and the ultraviolet lightwaves may be emitted within housing 302 to contact particles and/or interact with a catalyst otherwise provided within the housing 302.

In exemplary embodiments, ultraviolet light 324 is in communication with and actuatable by the PCB microprocessor 322 and/or main controller 250. Accordingly, PCB microprocessor 322 and/or main controller 250 may selectively actuate the ultraviolet light 324 to an on position wherein ultraviolet lightwaves are emitted or an off position wherein ultraviolet lightwaves are not emitted. Such selective actuation may, for example, be based on a user selected or factory-determined time period or be based on other suitable inputs from the PCB microprocessor 322 and/or main controller 250. For example, in some embodiments, the ultraviolet light 324 may be actuated on for a suitable time period after a door 128 is opened and then closed. This time period may be adjusted, either manually by a user or automatically by PCB microprocessor 322 and/or main controller 250, based for example, on the frequency with which door 128 is opened and shut or the length of time that door 128 is left open.

In some embodiments, air filter assembly 300 may further include a switch 326 which is actuatable by filter medium 319. For example, when the filter medium 319 is correctly positioned within the housing 302, such as in the interior 308, the filter medium 319 may contact the switch 326 and actuate it to a first mode, which may for example be an on mode (or an off mode). When the filter medium 319 is removed from the correct position within the housing 302, such as for replacement, the contact with the switch 326 may be terminated, actuating the switch 326 to a second mode, which may for example be an off mode (or an on mode).

In exemplary embodiments, switch 326 is in communication with the PCB microprocessor 322 and/or main controller 250. Accordingly, PCB microprocessor 322 and/or main controller 250 may track the time during which the switch 326 has been continuously actuated to the first mode, thus tracking the time during which the filter medium 319 has been installed for filter life and replacement purposes. Filter life and/or replacement recommendations can then be transmitted to, for example, a user interface display of the refrigerator appliance or to user interface device 270.

Notably, user interface device 270 may advantageously be utilized to interact with various components of the air filter assembly 300. For example, as discussed, user interface device 270 can receive data related to the switch 326 and filter medium 326, and may additionally receive data related to the ultraviolet light 324. Further, user interface device 270 may receive data related to the fan 316, which may for example indicate whether the fan 316 is actuated on or off. A user may additionally be able to transmit data signals to air filter assembly 300 to control operation of air filter assembly 300. For example, a user may be able to actuate the fan 316, set a timer for the fan 316, actuate the light 324, set a timer for the light 324, reset the timer that tracks switch actuation times 326, etc.

As discussed, in exemplary embodiments PCB microprocessor 322 is configured for data communication with the main controller 250, and the PCB microprocessor 322 and main controller 250 are thus in communication. Advantageously, the PCB microprocessor 322 and/or controller 250 may controller operation of the air filter assembly 300 and associate such air filter assembly 300 operation with operation of the refrigerator appliance 100. For example, in some embodiments, the air filter assembly 300 and various components thereof may only be operated when a door 128 is opened, or may only be operated when main refrigerator appliance 100 fans are operating. In some embodiments, air filter assembly 300 (such as the fan 316) may operate cooperatively with the main refrigerator appliance 100 fans, such that the fan 316 and main fans alternate operation or operate at different speeds when simultaneously operating. Further, in some embodiments the air filter assembly 300 and various components thereof may only be operated when the refrigerator appliance 100 is in a particular mode, such as a main cooling mode or non-defrost mode. In some embodiments, the air filter assembly 300 may only be operated when, for example, drawers 142 proximate the air filter assembly 300 are opened. In some embodiments, the air filter assembly 300 (such as the fan 316) may be operated at a particular predetermined slower speed during particular times, and at a particular predetermined higher speed during other particular times. For example, a slower speed may be utilized during times of day when users are likely to be in proximity to the refrigerator appliance 100 (i.e. at home, during meal times, etc.) and a higher speed may be utilized during times of day when users are not likely to be in proximity to the refrigerator appliance 100 (i.e. nighttime). If a user interface device 270 is utilized and locating features are enabled, these locating features could be utilized to determine whether a user is within a predetermined distance from the refrigerator appliance. A slower speed could be utilized when the user is within the predetermined distance, and a higher speed could be utilized when the user is without the predetermined distance.

With regard to operation of the ultraviolet light 324, in some embodiments the light 324 may only be operated with the refrigeration cycle apparatus of the refrigerator appliance 100 is not operating, in order to conserve energy. Additionally or alternatively, microprocessor 322 and/or main controller 250 may include suitable software for modulating power to the light 324 in order to stay below predefined power ratings for the refrigerator appliance 100.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance, comprising:
a cabinet defining a fresh food chamber;
a door for accessing the fresh food chamber;
a main controller configured to control refrigerator appliance operations;
a connector port in communication with the main controller and accessible within the fresh food chamber, the connector port configured to provide at least one of data communication with the main controller or electrical power;
an active air filter assembly, the air filter assembly comprising a housing, an inlet aperture defined in the housing, an outlet aperture defined in the housing, a fan disposed within the housing and operable to actively flow air through the inlet aperture and outlet aperture, and a connector plug connectable to the connector port to receive the at least one of data communication with the main controller or electrical power.

2. The refrigerator appliance of claim 1, wherein the connector port is configured to provide electrical power, and wherein the fan is powered by the electrical power from the connector port.

3. The refrigerator appliance of claim 1, wherein the connector port is configured to provide data communication with the main controller and electrical power.

4. The refrigerator appliance of claim 1, wherein the data communication is serial communication.

5. The refrigerator appliance of claim 1, wherein the connector port is a universal serial bus port and the connector plug is a universal serial bus plug.

6. The refrigerator appliance of claim 1, wherein the air filter assembly further comprises a process control block microprocessor.

7. The refrigerator appliance of claim 6, wherein the connector port is configured to provide data communication with the controller, and wherein the process control block microprocessor is configured for data communication with the controller.

8. The refrigerator appliance of claim 1, wherein the air filter assembly further comprises an ultraviolet light disposed within the housing.

9. The refrigerator appliance of claim 8, wherein the air filter assembly further comprises a process control block microprocessor, the ultraviolet light actuatable by the process control block microprocessor.

10. The refrigerator appliance of claim 1, wherein the air filter assembly further comprises a filter medium positioned to filter air flowed through the housing.

11. The refrigerator appliance of claim 10, wherein the air filter assembly further comprises a switch actuatable by the filter medium.

12. The refrigerator appliance of claim 11, wherein the air filter assembly further comprises a process control block microprocessor, the switch in communication with the process control block microprocessor.

13. The refrigerator appliance of claim 1, further comprising a wireless transmission device in communication with the controller and operable to wirelessly transmit data signals.

14. A refrigerator appliance, comprising:
a cabinet defining a fresh food chamber;
a door for accessing the fresh food chamber;
a main controller configured to control refrigerator appliance operations;
a connector port in communication with the main controller and accessible within the fresh food chamber, the connector port configured to provide serial communication with the main controller and electrical power;
an active air filter assembly, the air filter assembly comprising a housing, an inlet aperture defined in the housing, an outlet aperture defined in the housing, a process control block microprocessor configured for serial communication with the main controller, a fan disposed within the housing and operable to actively flow air through the inlet aperture and outlet aperture, and a connector plug connectable to the connector port to receive the serial communication with the main controller and electrical power, wherein the fan is powered by the electrical power from the connector port.

15. The refrigerator appliance of claim 14, wherein the connector port is a universal serial bus port and the connector plug is a universal serial bus plug.

16. The refrigerator appliance of claim 14, wherein the air filter assembly further comprises an ultraviolet light disposed within the housing.

17. The refrigerator appliance of claim 14, wherein the air filter assembly further comprises a filter medium positioned to filter air flowed through the housing.

18. The refrigerator appliance of claim 17, wherein the air filter assembly further comprises a switch actuatable by the filter medium.

19. The refrigerator appliance of claim 13, further comprising a wireless transmission device in communication with the controller and operable to wirelessly transmit data signals.

20. An active air filter assembly for connection to a connector port that is configured to provide serial communication and electrical power, the active air filter assembly comprising:
a housing;
an inlet aperture defined in the housing;
an outlet aperture defined in the housing;
a process control block microprocessor configured for serial communication through the connector port;
a fan disposed within the housing and operable to actively flow air through the inlet aperture and outlet aperture, the fan configured to be powered by the electrical power from the connector port; and
a connector plug connectable to the connector port to receive the serial communication and electrical power.
